(19) United States
(12) Patent Application Publication
(10) Pub. No.: US 2005/0139545 A1
(43) Pub. Date: Jun. 30, 2005

(54) Photo-processing and cleaning of pes and psf membranes

(75) Inventors: Masahide Taniguchi, Shiga (JP); Georges Belfort, Slingerlands, NY (US)

Correspondence Address: NOTARO AND MICHALOS, 100 DUTCH HILL ROAD, SUITE 110, ORANGEBURG, NY, 10962-2100, US

(73) Assignee: RENSSELAER POLYTECHNIC , A NEW YORK CORPORATION,, Troy, NY (US)

(21) Appl. No.: 10/506,932

(22) PCT Filed: Mar. 12, 2003
(86) PCT No.: PCT/US03/07657

Related U.S. Application Data
(60) Provisional application No. 60/363,700, filed on Mar. 12, 2002.
(60) Provisional application No. 60/363,701, filed on Mar. 12, 2002.
(60) Provisional application No. 60/363,711, filed on Mar. 12, 2002.

(51) Int. Cl. B01D 71/68

(52) U.S. Cl. 210/500.41; 210/500.35; 264/41

(57) ABSTRACT

A process for modifying a polymeric photoactive sulfone membrane includes placing the membrane into the presence of acrylic acid monomer dissolved in a solution and without sensitizer or free radical initiator and exposing the membrane to non-ionizing UV radiation for modifying the membrane by chemical grafting of the monomer at the surface of the membrane. The membrane can be polysulfone, polyethersulfone or polyarylsulfone. The radiation is selected to have an energy below that at which chain scission occurs and above that at which maximum grafting occurs. The process includes washing the modified membrane in a washing agent containing ethanol, glycol, ether, acid, hydrocarbon, or mixtures thereof, to wash homopolymer formed in the solution from the modified membrane, but preferably ethanol.

### CROSS REFERENCE TO RELATED APPLICATIONS

This application claims the benefit of provisional application Nos. 60/363,700, 60/363,701 and 60/363,711, which were all filed on Mar. 12, 2002 and which are all incorporated here by reference.

### FIELD AND BACKGROUND OF THE INVENTION

The present invention relates in general to ultra and micro-filtration membranes, and in particular to a new and useful method of making and composition for such membranes by graft polymerization of particularly effective monomers, by use of particularly effective and carefully selected energies of UV radiation for the grafting process, and by post irradiation cleaning of the membranes with a particular class of solvents not previously suggest.

U.S. Pat. No. 5,468,390, co-invented by one of the present co-inventors and which is also incorporated here by reference, discloses a photochemical grafting process that permits the attachment of free radically polymerizable monomers to the surface of aryl and ether polysulfone membranes. The process, which does not use sensitizers, results in membrane compositions that can be used for ultra and micro-filtration membranes and which exhibit low or non-fouling characteristics. Washing of the membrane in water is also taught. The membrane is then immersed in sulfuric acid for further processing, but this is not a washing process.

International patent application PCT/US01/31166, also co-invented by one of the co-inventors here and also incorporated here by reference, was only published after Mar. 12, 2002 but discloses a method for modifying a polymeric photo-active sulfone membrane that includes dipping the membrane into a solution of monomers containing a chain transfer agent, removing the membrane from the solution, exposing the membrane to UV radiation in the presence of a light filter, and washing the membrane in water.

The usefulness of such membranes has been fully disclosed in the above-identified U.S. patent and PCT application.

The following is a list of material references to the present invention:

M. Nystrom and P. Jarvinen, Modification of polysulfone ultrafiltration membranes with UV irradiation and hydrophilicity increasing agents, J. Membr. Sci., 60 (1987) 275-296.

Yamagishi, H., Crivello, J. and Belfort; G. (1995), Development of a novel photochemical technique for modifying poly(arylsulfone) ultrafiltration membranes, J. Membrane Sci., 105 237-247.

Yamagishi, H., Crivello, J. and Belfort, G. (1995), Evaluation of photochemically modified poly (arylsulfone) ultrafiltration membranes, J. Membrane Sci., 105 249-259.

Ulbricht, M and Belfort, G. (1995), Low Temperature Surface Modifications of Polyacrylonitrile Ultrafiltration Membranes—1. Plasma Treatment Effects, J. Appl. Polymer Sci., 56, 325-343.

Ulbricht, M. and Belfort, G. (1996), Surface modification of ultrafiltration membranes by low temperature plasma. II. Graft polymerization onto polyacrylonitrile and polysulfone, J. Membrane Sci., 111, 193-215.

Nabe, A., Staude, E. and Belfort, G. (1997) Surface modification of polysulfone ultrafiltration membranes and fouling of BSA solutions, J. Membane Sci., 133, 57-72.

U.S. Pat. No. 5,852,127 (Modification of Porous and Non Porous Materials Using Self-Assembled Monolayers).

Chen, C., and Belfort, G., (1999) Surface modification of poly(ether sulfone) ultrafiltration membranes by low temperature plasma induced graft polymerization, J. Applied Polymer Sci., 72, 1699-1711.

Boehme, P., Vedantham, G., Przybycien T. and Belfort, G. (1999) Self-assembled monolayers on polymer surfaces: kinetics, functionalization and photopatterning, Langmuir, 15, 5323.

Pieracci, J., Crivello, J. V. and Belfort, G (1999) Photochemical modification of 10 kD polyethersulfone ultrafiltration membranes for reduction of biofouling, J. Membrane Sci., 156, 223-240.

Pieracci, J, Wood, D. W., Crivello, J. V. and Belfort, G (2000) UV-assisted graft polymerization of n-vinyl-2-pyrrolidinone onto poly(ether sulfone) ultrafiltration membranes: Comparison of dip versus immersion modification techniques, Chem.Mater. 12, 2123-2133.

Kilduff, J. E., Mattaraj, S., Sensibaugh, J., Pieracci, J. P., and Belfort, G. (2001) Photochemical modification of poly(ether sulfone) and sulfonated poly(sulfone) nanofiltration membranes for control of fouling by natural organic matter. Desalination 132, 133-142.

Gineste et al, (1993) Grafting of acrylic acid with diethylkene glycol dimethacrylate onto radioperoxided polyethylene, J. Appl. Polym. Sci. 48,2113-2122.

Ulbricht et al, Gas phase photoinduced graft polymerization of acrylic acid onto polyacrylonitrile. ultrafiltration membranes, (1995) J. Appl. Polym. Sci. 55,1707-1723.

For convenience, some of the acronyms used in this disclose are listed as follows:
AA acrylic acid
AAG 2-acrylamidoglycolic acid monohydrate
AAm acrylamide
AAP 2-acrylamido-2-methyl-1-propanesulfonic acid
AMPS 2-acriloamido-2-methyl-1-propanesulfonic acid
BSA bovine serum albumin
DG degree of grafting
GMA glycidyl methacrylate
HEMA 2-hydroxyethyl methacrylate
HPMA 2-hydroxypropyl methacrylate
MAc methacrylic acid
NOM natural organic matter
NVC N-vinyl caprolactam
NVF vinylformamide
NVP N-vinyl-2-pyrolidinone
PBS phosphate buffered saline
PES polyether sulfone
PSF polyaryl sulfone
SPMA sulfopropyl methacrylate.

Various problems persist in this field, which the present invention seeks to correct.

Prior Selection of Appropriate Monomers:

The surface chemistry of filtration membranes is generally chosen so that it repels or exhibits minimum attractive interaction (preferably a positive repulsion interaction) with the particular solute (i.e. protein or NOM). NVP monomer has been most widely used by the group including one of the co-inventors here, however, several other monomers have been photo-grafted onto PES and PSf and tested for efficacy of reducing fouling with test solutions containing BSA as a model protein for biotechnology applications. These known monomers include AA but only with photoinitiator present in the process. Other previously used monomers are: HEMA, GMA, MAc, AAm, HPMA, NVP, NVC, NVF, AAG, SPMA, AAG and AMPS.

The only previous use of AA during photo-induced graft polymerization was by Gineste et al. and Ulbricht et al. Neither of these efforts teach using photo-induced graft polymerization without a photoinitiator for PES membranes.

Gineste et al. grafted mixed AA/diethylkene glycol dimethacrylate monomers onto radioperoxided polyethylene (not a photo-oxidative process), while Ulbricht et al. used respectively, low temperature plasma and an initiator with a photo-induced graft polymerization process and polyacrylonitrile membranes. The publications by theses researches do not teach how to use AA monomer with photo-induced graft polymerization of PES without a photo-initiating agent. Also, no one has compared the wettability, the degree of grafting (DG), and the filtration performance to hydraulic permeation flow after water cleaning and back-flushing.

The prior art provides no guidance on how to choose the best monomer (and hence grafted polymer) with photo-induced graft polymerization of PES for a specific filtration application.

No Guidance on Selection of Irradiation Energy:

The research group that includes the present inventors and other researchers have used graft-induced photo-polymerization of vinyl monomers for modifying the surfaces of polymeric membranes so as to match their surface properties with specific applications. The prior art, however, does not teach or suggest guidelines on how to optimize filtration performance using such methods.

If too low an UV-irradiation energy is used, then insufficient grafting and polymerization is obtained and the surface is not modified adequately and fouling will occur during filtration. On the other hand, if too much UV-irradiation energy is used, then too frequent chain scission of the bulk polymer will result in too many open pores, with concomitant loss of solute (i.e. protein) rejection and too high a permeation flux. Previously grafted polymers are also knocked from the membrane and homopolymerization increases with too much irradiation. There are currently no guidelines on how to balance these two opposing criteria except for varying the operating parameters (wavelength, exposed radiation energy for a given time-intensity, monomer and synthetic membrane polymer).

Prior Membrane Washing:

It is known to wash the membranes, after the photo-grafting process, with water. Unwanted homopolymerization, that is, the unwanted polymerization in solution and not grafted onto the polymer membrane surface, occurs during many UV modification applications, i.e. the immersion and dip method of the above-identified International patent application PCT/US01/31166. This is because of the simultaneous process of grafting and homo-polymerization where irradiation is applied in the presence of monomer. Homopolymer is formed in the pores of the membrane as well as outside the pores on the membrane surface and in solution. It is trapped in the pores and is difficult to remove by washing with water.

These homopolymer plugs increase permeation resistance and results in significant decline in filtration performance. Also, they may be released from the pores and cause unknown and unexpected changes in the process.

The present invention provides a solution to each of these problems.

### SUMMARY OF THE INVENTION

An object of the present invention is to provide ultra or micro-filtration membrane products and method of making the same, using grafting of AA (acrylic acid) monomers on its surface. The membranes exhibit low protein fouling, and maintain a greater fraction of the original membrane permeability and retention properties after modification.

Another object of the present invention is to provide ultra or micro-filtration membrane products and method of making the same, using optimum irradiation energies.

A still further object of the present invention is to provide ultra or micro-filtration membrane products and method of making the same, including a post-irradiation, washing step using ethanol or similarly active solvent to greatly improve membrane performance.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a graph depicting irreversible resistance (R_{F}−R_{M}) after BSA filtration versus wettability;

FIG. 2 is a graph depicting irreversible resistance (R_{F}−R_{M}) after NOM filtration versus wettability;

FIG. 3 is a graph depicting the relationship between the ratio of the PBS buffer solution permeation resistance, R_{M,PBS} to the water permeation resistance, R_{M} versus degree of grafting for the following monomers used during photo-induced graft polymerization;

FIG. 4 is a grid of schematic drawings illustrating the flow through a pore lined with grafted polymer for feeds at different ionic strengths and different degrees of grafting (DG);

FIG. 5 is a graph depicting change in degree of grafting (DG) versus the product of monomer concentration, C [M] and UV irradiation time, t [s];

FIG. 6 is graph showing DI water permeation resistance versus ethanol concentration in wash water after photograft-induced polymerization of NVP with 50 kDa polyether sulfone membranes (2 wt % NVP, E=7.8 kJ/m²) and with post treatment washing in water and ethanol for 24 hours;

FIG. 7 is graph comparing degrees of grafting of PES membranes after washing in ethanol (DG_{E}) and in water (DG_{W}), expressed as the ratio of DG_{W}/DG_{E} versus irradiation energy for the shown wt % of NVP;

FIG. 8 is a graph illustrating the effect of irradiation energy on the degree of grafting after washing in ethanol (DG_{E}) for photo-grafting conditions 2 wt % NVP and PES MWCOs 50 kDa for the solid circles, 70 kDa for the solid squares and 100 kDa for the solid triangles and where E2 is the energy needed to obtain maximum NVP grafting and E1 is the energy below which chain-scission is thought to be minimized;

FIG. 9 is a graph like FIG. 8 but for 5 wt % NVP;

FIG. 10 schematically illustrates the graft-induced photo-oxidation process with increasing E at, (a) production of the first set of. radical sites, (b) NVP grafting and production of the second radical sites, (c) growth of graft chain, new grafting and production of the third set of radical sites, and (d₁) additional growth and production for the case where UV light interacted with previously ungrafted membrane surface or (d₂) the case where the UV light interacted directly with a grafted chain causing it to cleave chain;

FIG. 11 is a graph plotting vertical distance analyzed from the topography of the membrane surface measured by atomic force microscopy verses irradiation energy for 2 wt % NVP;

FIG. 12 is a graph like FIG. 11 but for 5 wt % NVP;

FIG. 13 is a graph plotting horizontal distance from the topography of the membrane surface measured by atomic force microscopy verses irradiation energy for 2 wt % NVP; and

FIG. 14 is a graph like FIG. 13 for 5 wt % NVP.

### DESCRIPTION OF THE PREFERRED EMBODIMENTS

The drawings illustrate and demonstrate various aspects of the present invention.

Selection of Appropriate Monomers:

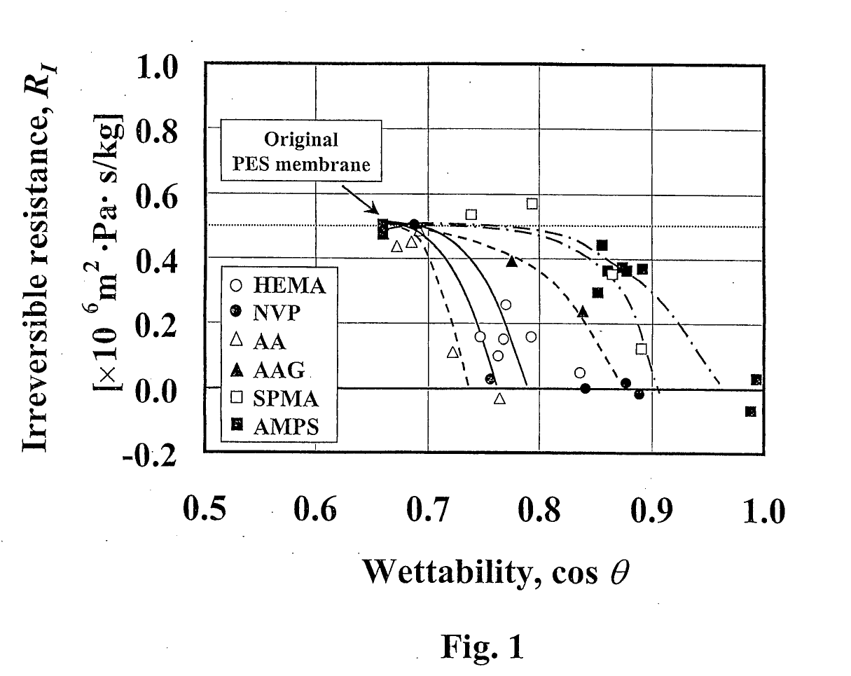

Referring to FIGS. 1 to 5; many monomers have been evaluated to reduce fouling during protein filtration in the past. Efficacy in reducing fouling, ability to graft (graft sensitivity), efficiency of grafting, homopolymer formation, absoptivity of light and optical filterability, are all characteristics that effect monomer efficacy in reducing fouling. The main goal is to choose a monomer that wets the PES membrane more effectively than other monomers during the photo-graft induced polymerization, and that does not cause a significant change in solute retention or a large change in permeation volume flux.

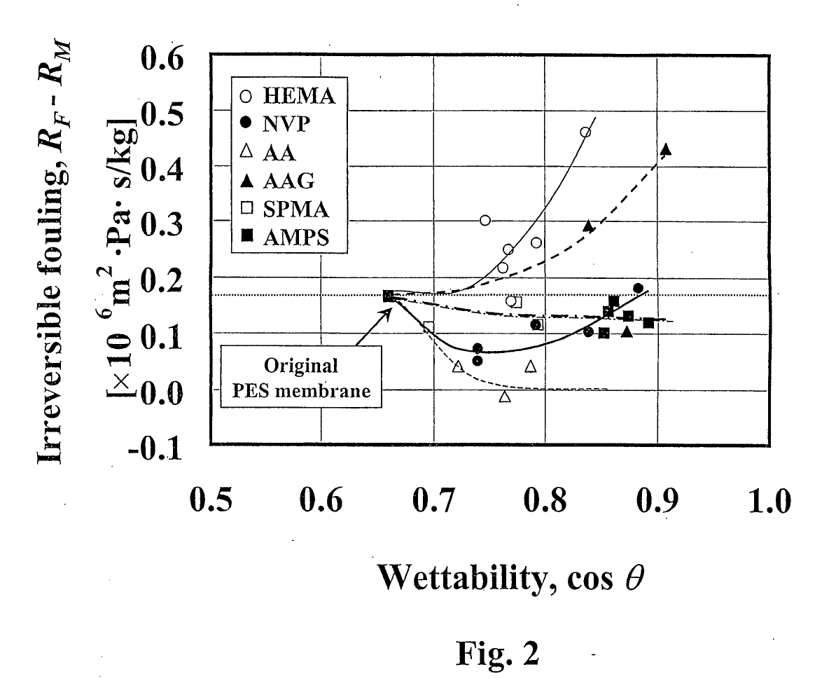

The present inventors have found that AA (acrylic acid), a weak acid monomer, is an extremely good and perhaps the best monomer for use with photo-induced graft polymerization of PES (PES-g-AA) in reducing fouling of proteins and NOM. As a result of the research work on different monomers for BSA (for biotechnology) and NOM (for water treatment) FIGS. 1 and 2 demonstrate that AA, a weak acid, obtains R_{I} =0, at the least wettability value (cos θ˜0.75-78 for BSA and NOM filtration) and as compared with all the other monomer tested. This shows that either AA is more efficient in covering the surface or more effective during the grafting process in attaching to the surface and polymerizing or both. It is not currently known if this is due to more grafts per unit area or longer grafts that cover more area, but in any case the results are clearly and unexpectedly improved over the other monomers used to date. Note that all the monomers appear to reach R₁=0 for protein filtration and fouling (FIG. 1) while only AA is able to reach R₁=0 for NOM filtration and fouling (FIG. 2).

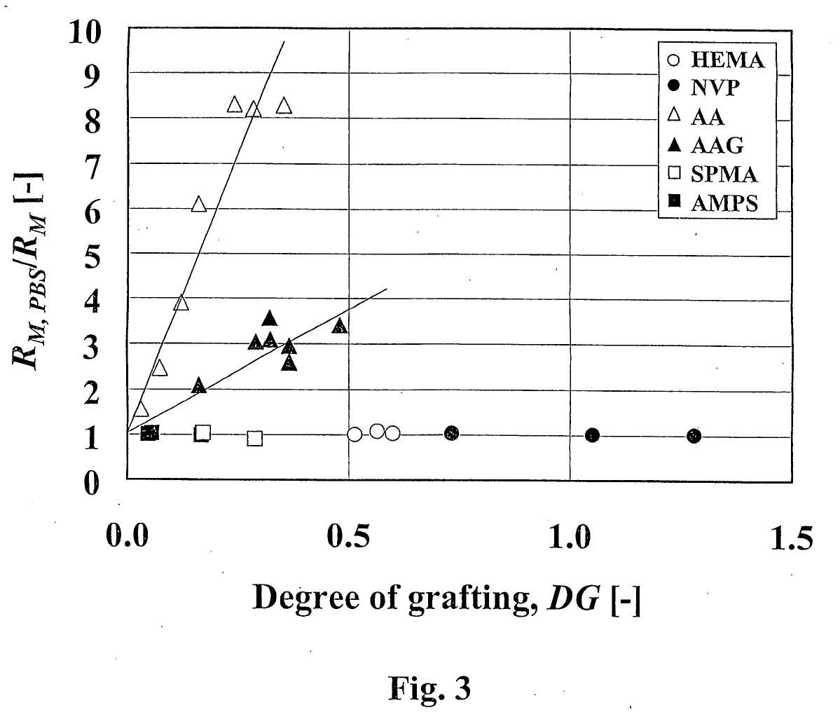

FIG. 3 displays an important property of AA and AAG, both weak acids, i.e. they can behave as switches and offer increasing resistance to flow with increasing DG at high ionic strengths in the flowing solution. Thus, the ratio of the PBS buffer solution permeation resistance, R_{M,PBS} to the water permeation resistance, R_{M} was linear for increasing degree of grafting, DG. AA is known to have a helix-like structure that coils and uncoils (becomes rod-like) at low salt concentrations. Clearly, as the DG increases, the salt in the feed solution is less effective in stretching the AA polymers due to their increase proximity to one-another (steric hindrance). Thus at low salt concentration, the AA polymers are permeable and the permeation flux is high (i.e. R_{M,PBS}/R_{M} is low), while at high salt concentrations, the AA polymers can pack more closer and present a denser layer to the flowing fluid resulting in an increase in R_{M,PBs}/R_{M}.

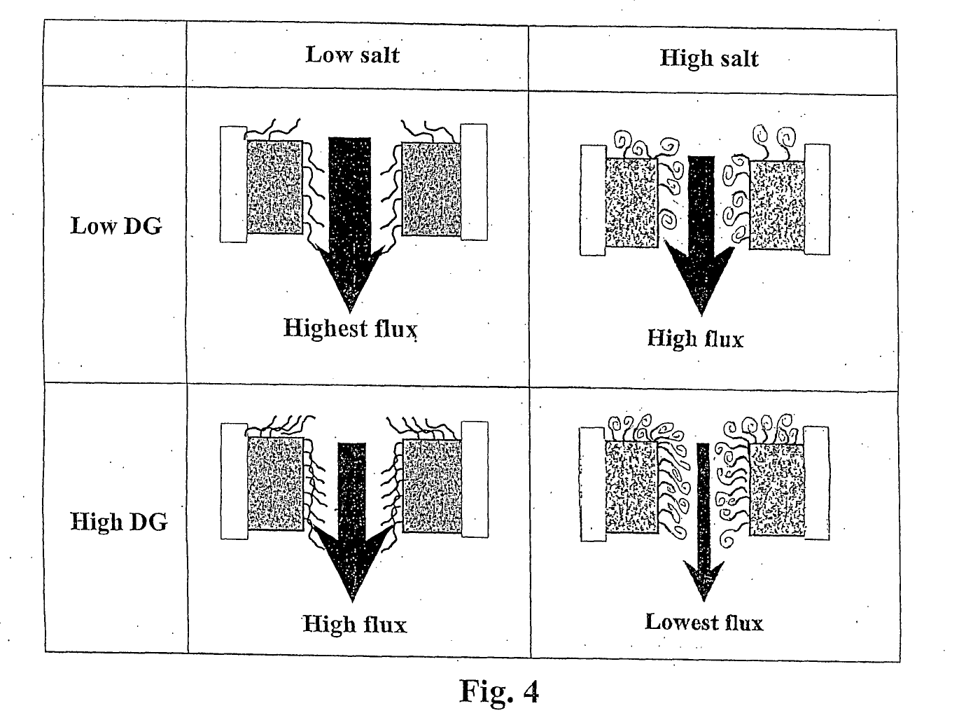

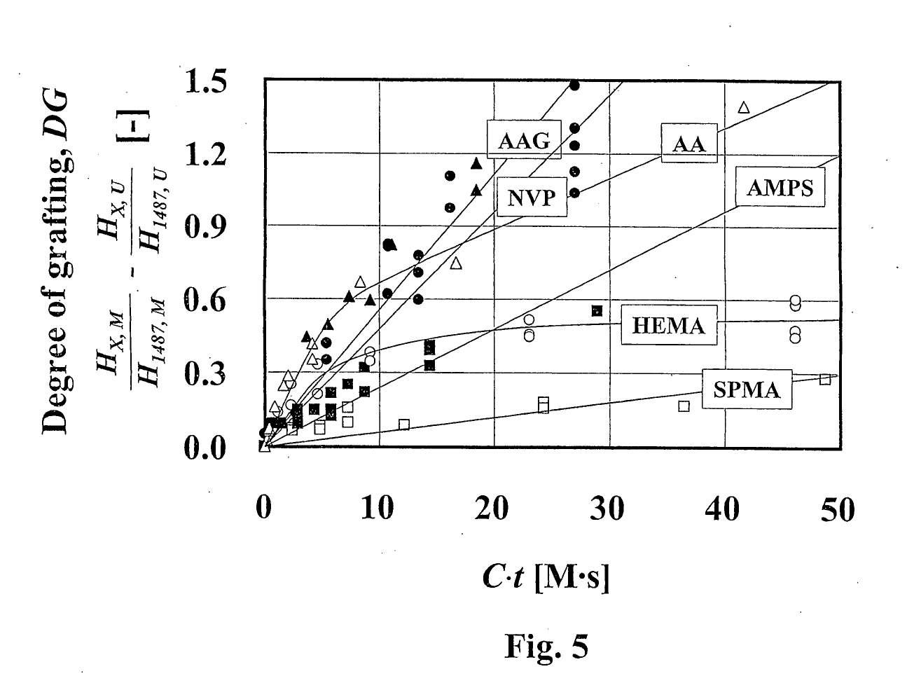

A schematic illustration of these effects are shown in FIG. 4. Additional evidence that AA is the best monomer tested is shown in FIG. 5, where AA and AAG exhibit the steepest initial slope (measure of sensitivity) of all the monomers. AA (71 kDa) is the smallest monomer (lowest molecular weight) tested in this study and is the best monomer in our group at reducing the R_{I} values for BSA and NOM filtration, is tunable with salt (can make it coil or stretch and hence offer more or less resistance to flow) and it is the most sensitive to UV grafting at low Ct-values (exhibits the highest degree of grafting).

Advantage of this feature of the invention include the fact that PES membranes with AA-grafted on the surface give the best filtration performance for protein filtration and for water treatment (lowest protein fouling and lowest NOM fouling) and this monomer is of interest because it is tunable (with salt) and the most sensitive monomer, in terms of DG, yet seen.

Instead of changing the ionic strength (salt concentration), one could change the acidity (i.e. use a pH swing) which could achieve the same effect. However, a pH swing is not as attractive as a salt change because it may have problems such as the effect of pH on the solute (protein or NOM) or on the PES membrane. It could also be harmful and costly.

An example of use of the invention is as a post-treatment after casting, the synthetic polyether sulfone and polyaryl sulfone membranes can be modified using photo-induced graft polymerization.

Membrane Washing:

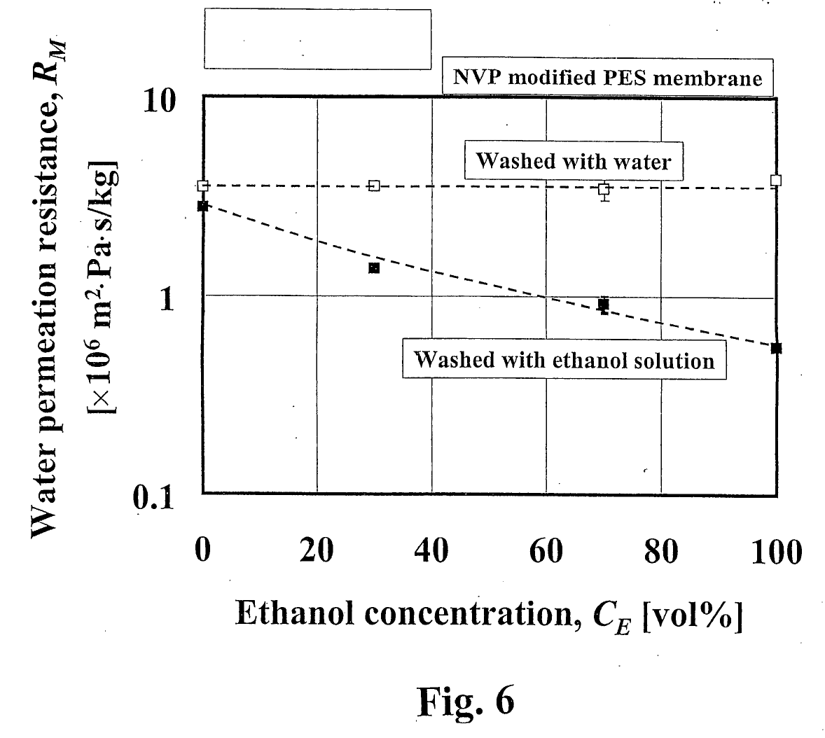

Referring to FIG. 6, this aspect of the invention is a method to remove homopolymer from the pores of the membranes after photo-induced graft polymerization of synthetic membranes. Ethanol (or other membrane compatible solvents as will be listed below) effectively removes homopolymer from the pores and surface of polyether sulfone or other membranes.

FIG. 6 shows that the resistance decreases (with a concomitant performance increase) when ethanol is used to wash the membrane as opposed to water. Ethanol (and other membrane compatible solvents that dissolve the polymerized homopolymer of the monomer) changes the pore structure through swelling and helps remove homopolymer from the membrane. Swelling of the membrane is thought to play an important part in dislodging, dissolving and extracting the homopolymer from the pores of the membrane.

Alternative washing agents are other solvents or their mixtures could be used such as other alcohols besides ethanol, as well as glycol, ether, acid, hydrocarbon, or their mixtures. They should not dissolve the membrane but swell it to some extent so as to dislodge the homopolymer and should dissolve and extract the homopolymer from the membrane.

Examples of use of the invention are as a post-treatment after modifying synthetic polyether sulfone and polyaryl sulfone membranes using photo-induced graft polymerization.

According to this aspect of the invention, NVP was used as the monomer and the dip-modification technique of the above-identified international application was used on PES membranes. The membranes were first washed and then dipped in NVP solution for 30 min with stirring at 22° C. After removal and purging with N₂ Irradiation took place using 300 nm UV lamps (˜15% of the energy was below 280 nm). The energy level was E=7.8 kJ/m². Washing in ethanol according to the invention then followed which involved dipping the membrane in ethanol for 24 hours.

Selection of Irradiation Energy:

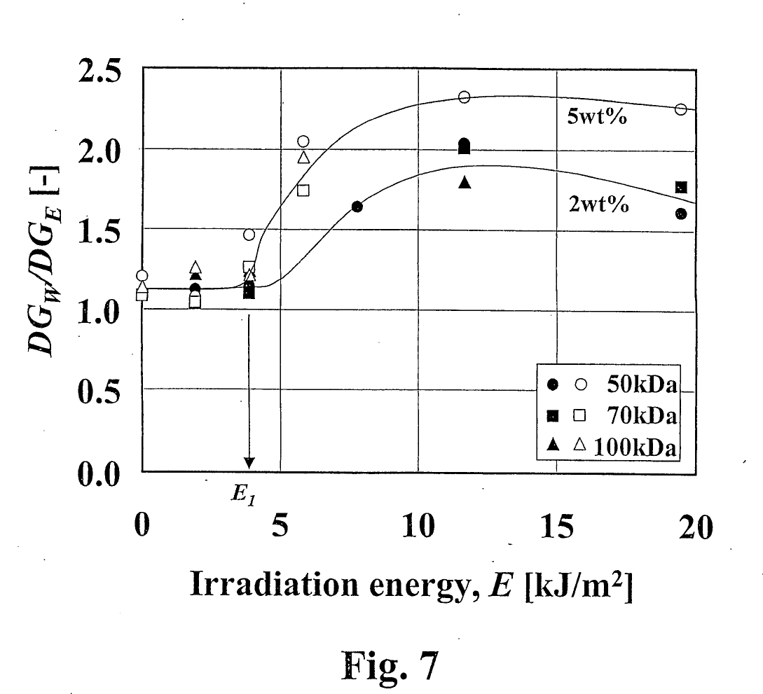

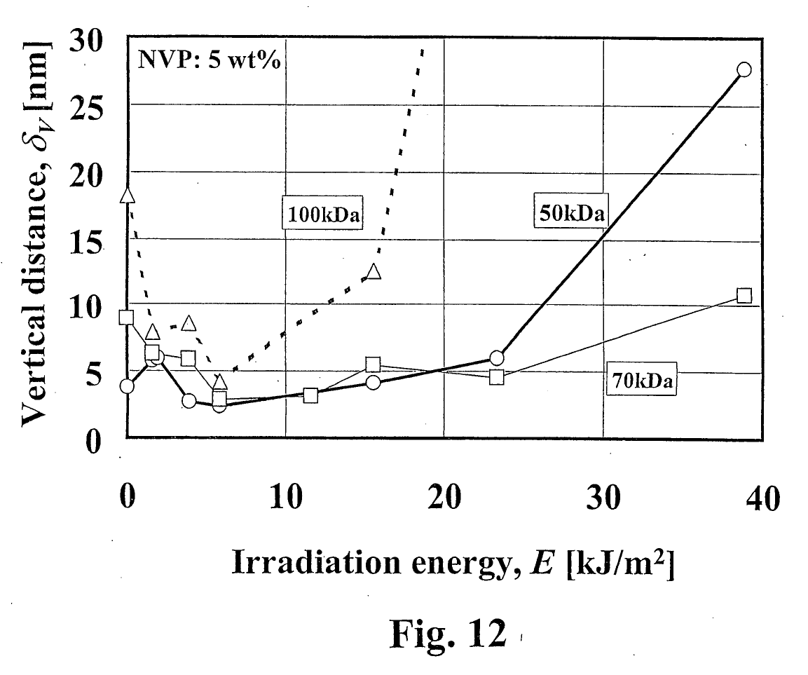

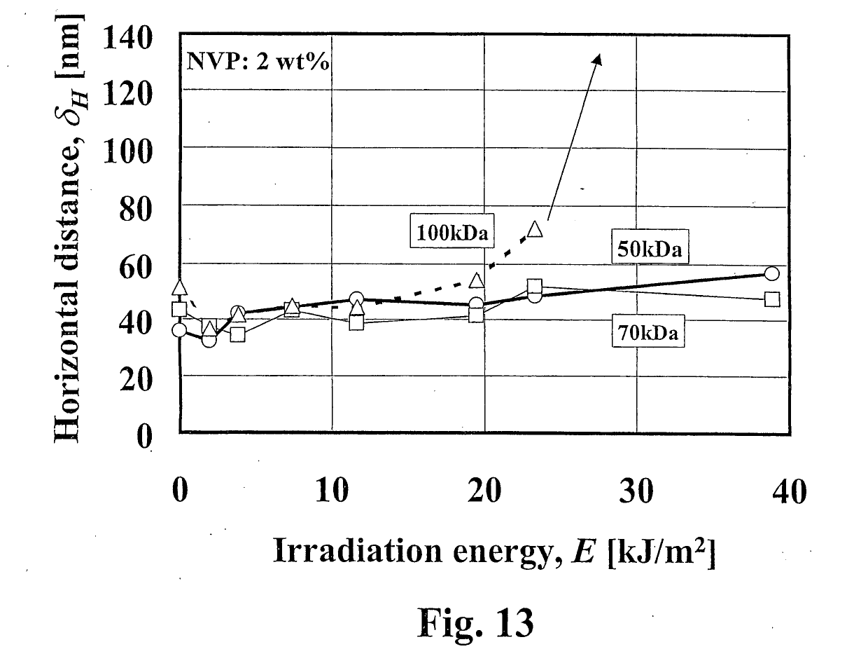

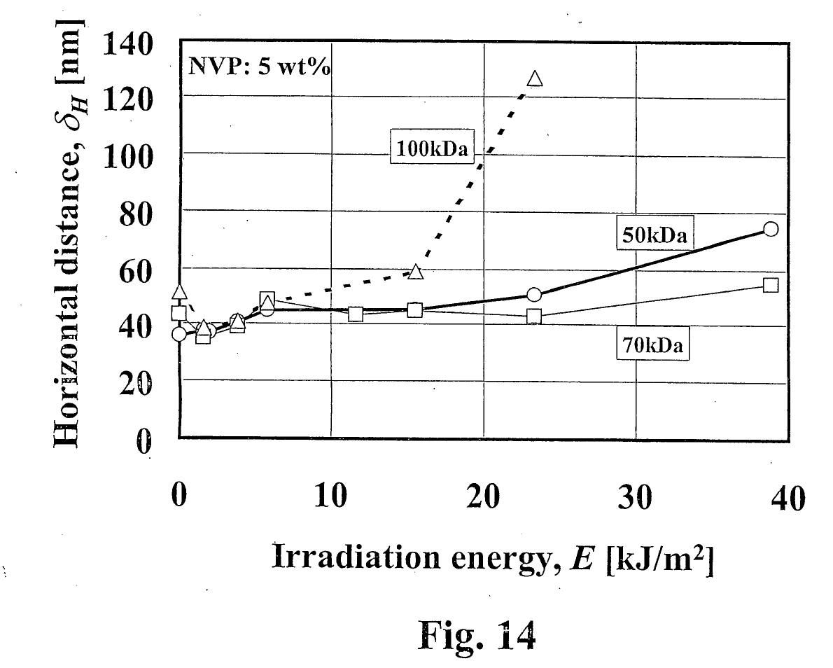

The present invention as illustrated in FIGS. 7 to 14, establishes a set of guidelines for obtaining a photo-grafted synthetic polymer membrane with optimal performance (low fouling, high solute (protein) retention, and acceptable permeation fluxes). The method involves choosing a radiation energy (E1) below which abundant chain scission (surface damage) is minimized and a radiation energy (E2) at which maximum degree of grafting (DG, measures the amount of polymer grafted onto the membrane surface) is obtained. An example with the three PES polymer synthetic membranes with molecular weight cut-offs (MWCO) of 50, 70 and 100 kDa, N-vinyl pyrolidinone (NVP) monomer at 2 and 5 wt %, and irradiation at 300 nm wavelength, of DG ratio (DG_{W}/DG_{E} where DG_{W} and DG_{E} are the DG values after irradiation and post-washing with water (W) and ethanol (E), respectively) versus amount of irradiation energy (E) directed toward the membrane is shown in FIG. 7.

Ethanol is able to extract the entrapped homopolymer and other fragments from the pores (see above) while water is unable to do this effectively.

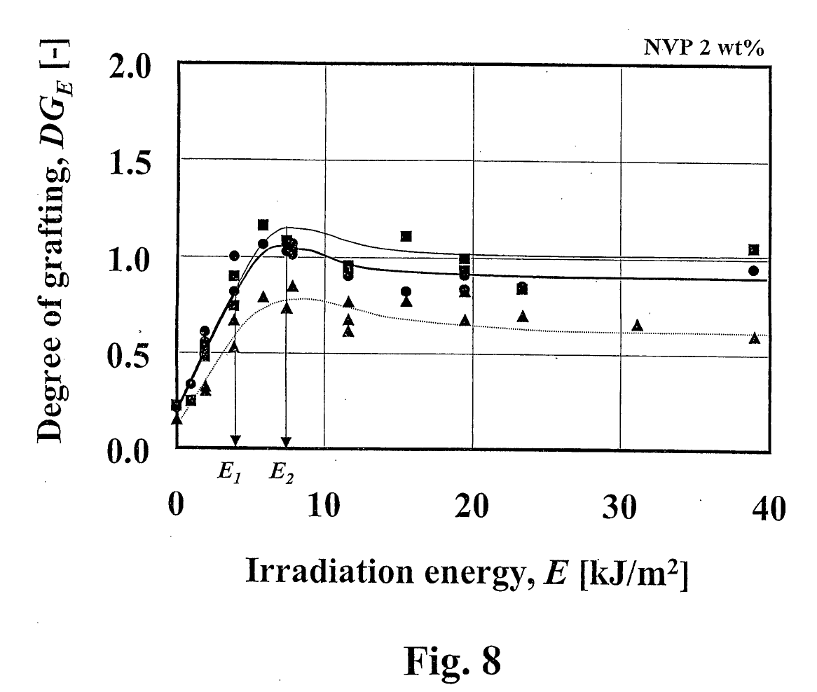

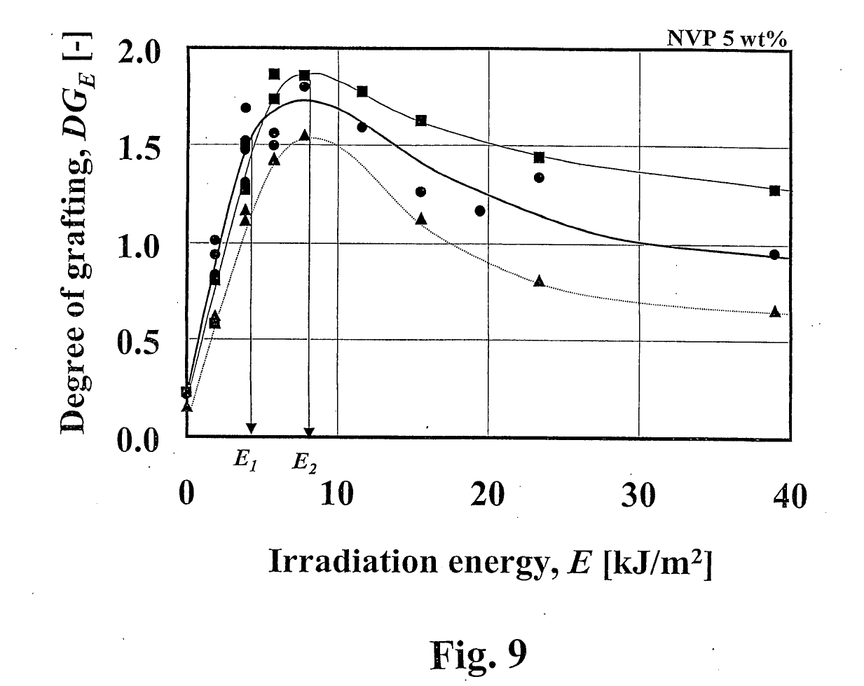

The data in FIG. 7 shows that the critical energy to prevent the surface destruction, E1, is 4 kJ/m2 for PES membranes. DG_{E} is plotted against E for the same system as described above in FIGS. 8 and 9. The data in FIGS. 8 and 9 also show that E1 can be found on the linear part of the curve where E1<E2. The maximum DG (E2) appears at a larger irradiation energy than E1 and is similar for all three membranes (50, 70 and 100 kDa) and at 2 and 5 wt % NVP. For reduced pore damage, E1 should be found, and for maximum DG, E2 should be sought.

FIG. 8 shows that for PES membranes grafted in NVP solutions, grafting grew linearly at low irradiation (<4-5 kJ/m²) which suggests that cleavage and graft polymerization occurred. At larger irradiation energy (˜8 kJ/m²), DG reached a maximum for all concentrations and energies.

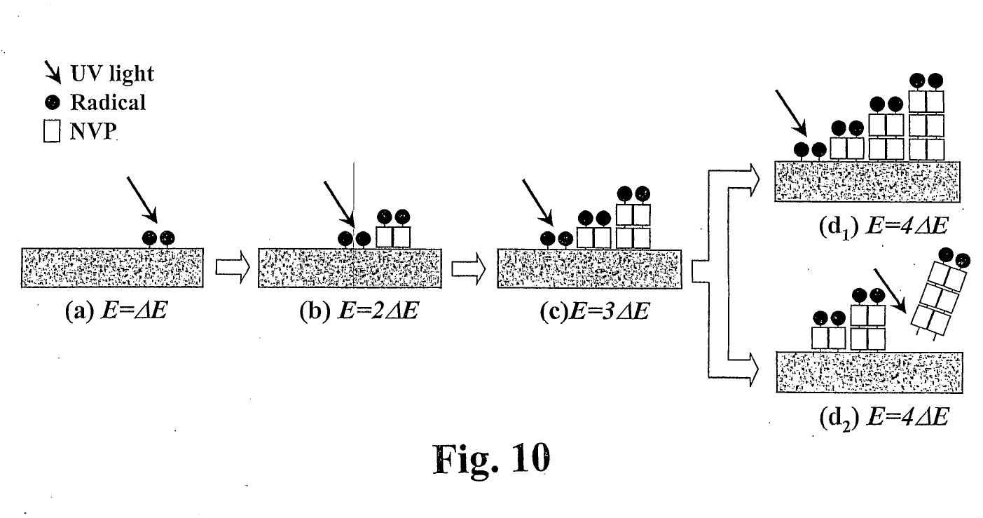

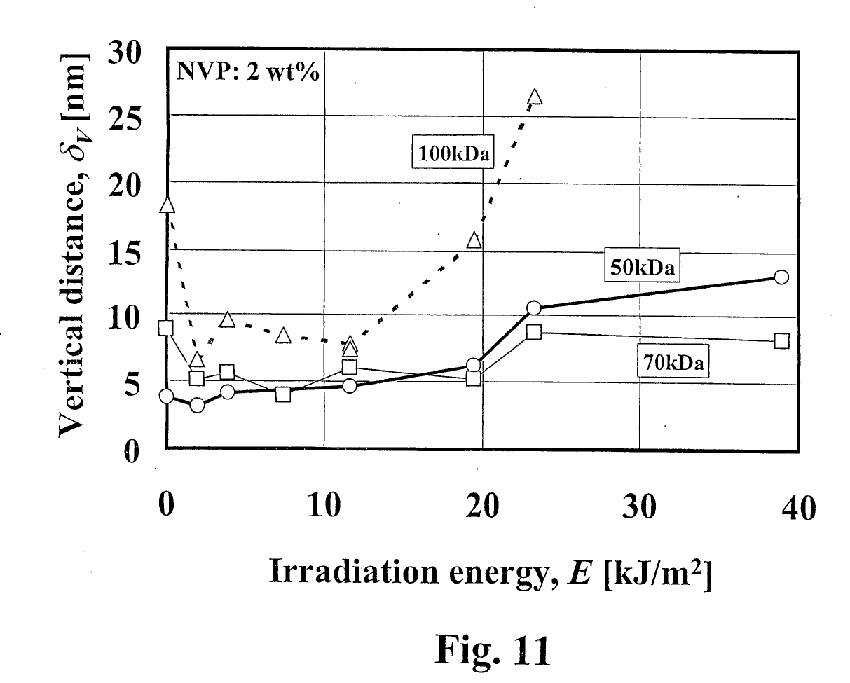

A possible mechanism of theses competitive processes is presented in FIG. 10. Evidence that photo-oxidation affects the pore structure and hence surface roughness, topographical roughness data (mean heights, d_{V}, and widths, d_{H}, of roughness protrusions measured with an atomic force microscope, AFM) is presented in FIGS. 11 to 14. Notice the dip in roughness after some grafting (usually around E1 and E2) and then the increase in roughness at high E-values (>E2) suggesting severe surface damage due to excessive chain scission.

Advantages of the invention include the fact that guidelines are provided that allow surface modification by photo-induced grafting to be conducted with minimum damage and with sufficient DG for optimal performance. Irradiation below E2 should be used for maximum DG (see the fall-off in DG above E2 in FIG. 8), and irradiation near E1 should be used for best DG_{W}/DG_{E} ratio values (see the increase in this ratio above E1 in FIG. 7).

Uses of the the invention include a guide for modifying synthetic polyether sulfone and polyaryl sulfone membranes with photo-induced graft polymerization.

While specific embodiments of the invention have been shown and described in detail to illustrate the application of the principles of the invention, it will be understood that the invention may be embodied otherwise without departing from such principles.

1. A process for modifying a polymeric photoactive sulfone membrane comprising:
placing the polymeric photoactive sulfone membrane into the presence of acrylic acid monomer dissolved in a solution and without sensitizer or free radical initiator; and
exposing the membrane to non-ionizing UV radiation for a selected period of time for modifying the membrane by chemical grafting and attachment of the monomer at the surface of the membrane by covalent bonding without any sensitizer or free radical initiator.

2. A process according to claim 1, further comprising selecting the polymeric photoactive sulfone membrane from the group consisting of polysulfone, polyethersulfone, and polyarylsulfone.

3. A process according to claim 1, wherein the UV radiation for exposing the membrane is selected to have an energy below an energy (E2) at which a maximum degree of grafting onto the membrane surface occurs in a graph plotting degree of grafting against irradiation energy, and near an energy (E1) below which chain-scission is minimized.

4. A process according to claim 1, further including washing the modified membrane in a washing agent containing a solvent selected from the group consisting of ethanol, glycol, ether, acid, hydrocarbon, or mixtures thereof, which agent is adapted to wash homopolymer formed in the solution, from the modified membrane.

5. A process for modifying a polymeric photoactive sulfone membrane comprising:
placing the polymeric photoactive sulfone membrane into the presence of a solution containing at least one monomer; and
exposing the membrane to UV radiation for modifying the membrane by chemical grafting and attachment of the monomer at the surface of the membrane, the UV radiation having an energy selected to be below an energy (E2) at which a maximum degree of grafting onto the membrane surface occurs in a graph plotting degree of grafting against irradiation energy, and near an energy (E1) below which chain-scission is minimized.

6. A process according to claim 5, further comprising selecting the polymeric photoactive sulfone membrane from the group consisting of polysulfone, polyethersulfone, and polyarylsulfone.

7. A process according to claim 5, further including washing the modified membrane in a washing agent containing a solvent selected from the group consisting of ethanol, glycol, ether, acid, hydrocarbon, or mixtures thereof, which agent is adapted to wash homopolymer formed in the solution, from the modified membrane.

8. A process for modifying a polymeric photoactive sulfone membrane comprising:
placing the polymeric photoactive sulfone membrane into the presence of a solution containing at least one monomer;
exposing the membrane to UV radiation for modifying the membrane by chemical grafting and attachment of the monomer at the surface of the membrane, the monomer also forming homopolymer in the solution which is not graphted to the membrane; and
thereafter washing the modified membrane in a washing agent containing a solvent selected from the group consisting of ethanol, glycol, ether, acid, hydrocarbon, or mixtures thereof, which agent is adapted to wash the homopolmer from the modified membrane.

9. A process according to claim 8, further comprising selecting the polymeric photoactive sulfone membrane from the group consisting of polysulfone, polyethersulfone, and polyarylsulfone.

10. A modified polymeric photoactive sulfone membrane made by the process comprising:
placing the polymeric photoactive sulfone membrane into the presence of acrylic acid monomer dissolved in a solution and without sensitizer or free radical initiator; and
exposing the membrane to non-ionizing UV radiation for a selected period of time for modifying the membrane by chemical grafting and attachment of the monomer at the surface of the membrane by covalent bonding without any sensitizer or free radical initiator.
